(19) United States
(12) Patent Application Publication
(10) Pub. No.: US 2016/0223356 A1
(43) Pub. Date: Aug. 4, 2016

(54) LIGHT-EMITTING PEDOMETER SNEAKER

(71) Applicant: TAIWAN KANGDEXIN COMPOSITE MATERIAL CO., LTD., HSINCHU COUNTY (TW)

(72) Inventors: PO-HUNG YAO, HSINCHU COUNTY (TW); JHIH-PING LU, HSINCHU COUNTY (TW); WEN-HSUN YANG, HSINCHU COUNTY (TW); HSIAO-PING LIANG, HSINCHU COUNTY (TW)

(21) Appl. No.: 15/003,974

(22) Filed: Jan. 22, 2016

(30) Foreign Application Priority Data
Jan. 29, 2015 (TW) 104201450

(51) Int. Cl. G01C 22/00; F21V 23/02; F21V 23/00; A43B 3/00; F21V 33/00

(52) U.S. Cl. CPC G01C 22/006; A43B 3/001; F21V 33/0008; F21V 23/003; F21V 23/023; F21Y 2101/02

(57) ABSTRACT

A light-emitting pedometer sneaker includes a body, at least one multicolor light-emitting unit and a pedometer module. The multicolor light-emitting unit is mounted on a vamp of the body. The pedometer module is mounted on a sole of the body, calculates a number of steps that a user has walked according to vibration generated when the user is walking, and controls a color of light emitted from the multicolor light-emitting unit. The user can be aware of the number of steps that the user has walked according to the color of the light emitted from the multicolor light-emitting unit and plans for a desired amount of exercise for the purpose of adequate exercise. The light-emitting pedometer sneaker can emit light in the dark to warn vehicles in the neighborhood off and avoid occurrence of a traffic accident.

### BACKGROUND OF THE INVENTION

1. Field of the Invention

The present invention relates to a shoe and, more particularly, to a light-emitting pedometer sneaker.

2. Description of the Related Art

As paying more attention to health, modern people tend to exercise or do workout during their leisure time. Walking or jogging could be some of the most economic and effective exercises. However, excessive amount of exercise oftentimes overloads or even injures the body. Not only can't attainment of exercise and workout goal be fulfilled, but also the likelihood of body injury increases. Hence, appropriate amount of exercise and rest is necessary. Carrying a pedometer to calculate the amount of exercise during walking or jogging could be one of the options that people from all walks of life will choose.

A pedometer installed in a conventional pedometer sneaker can be adopted to calculate the number of steps that users have walked or jogged and a current amount of exercise according to the number of steps and to further plan for a desired amount of exercise with users' physical conditions taken into account. However, to observe the number of steps that users have walked or jogged, users have to bend over their bodies to watch the number of steps displayed on the pedometer. Additionally, when wearing the pair of conventional pedometer sneakers to walk or jog in the night time, because of poor visibility, users have to beware of obstacle in the path of walking or jogging and also stay alert at vehicles in the neighborhood. Supposing that a conspicuous light-emitting or reflective device is not equipped, unexpected accident may happen when people doing walking or jogging is ignored by drivers of the vehicles around.

### SUMMARY OF THE INVENTION

An objective of the present invention is to provide a light-emitting pedometer sneaker capable of recording a number of steps that a user has walked or jogged, and emitting light with different colors to remind the user of the number of steps and to warn off vehicles in the neighborhood for avoidance of traffic accident.

To achieve the foregoing objective, the light-emitting pedometer sneaker includes a body, at least one multicolor light-emitting unit, a pedometer module and a power supply module.

The body has a sole and a vamp. The vamp is mounted around a top edge of the sole.

The at least one multicolor light-emitting unit is mounted on the vamp of the body.

The pedometer module is mounted on the sole of the body and is electrically connected to the multicolor light-emitting unit to record a number of steps and to control a light-emitting rule of light emitted from the multicolor light-emitting unit according to the recorded number of steps.

The power supply module is mounted inside the sole and is electrically connected to the multicolor light-emitting unit and the pedometer module to supply an operating power to the multicolor light-emitting unit and the pedometer module.

Given the pedometer module, the color of light emitted from the at least one multicolor light-emitting unit can be controlled to remind a user of the number of steps that a user has walked or jogged according to the color of the emitted light. Accordingly, the user can have a personal exercise plan according to a current amount of exercise. Additionally, the light-emitting pedometer sneaker emits light in the dark and thus warns off vehicles in the neighborhood for avoidance of traffic accident.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a first embodiment of a light-emitting pedometer sneaker in accordance with the present invention;

FIG. 2 is a schematic view of a second embodiment of a light-emitting pedometer sneaker in accordance with the present invention;

FIG. 3 is a schematic view of a third embodiment of a light-emitting pedometer sneaker in accordance with the present invention in collaboration with a mobile device;

FIG. 4 is a schematic view of the light-emitting pedometer sneaker in FIG. 3 collaborated with a health management system;

FIG. 5 is a functional block diagram of the light-emitting pedometer sneaker in FIG. 1;

FIG. 6 is another functional block diagram of the light-emitting pedometer sneaker in FIG. 1;

FIG. 7 is a functional block diagram of the light-emitting pedometer sneaker in FIG. 2;

FIG. 8 is a functional block diagram of the light-emitting pedometer sneaker in FIG. 3; and

FIG. 9 is a functional block diagram of the light-emitting pedometer sneaker collaborated with the health management system in FIG. 4.

### DETAILED DESCRIPTION OF THE INVENTION

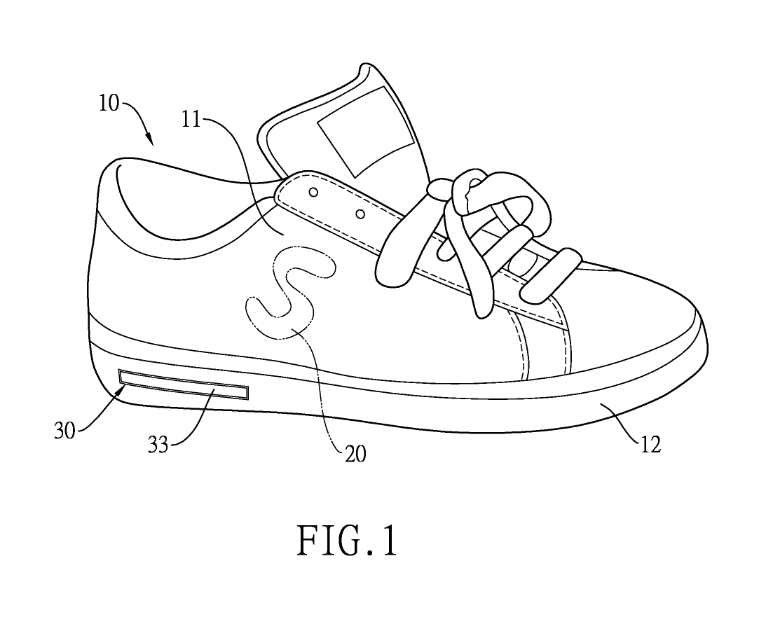

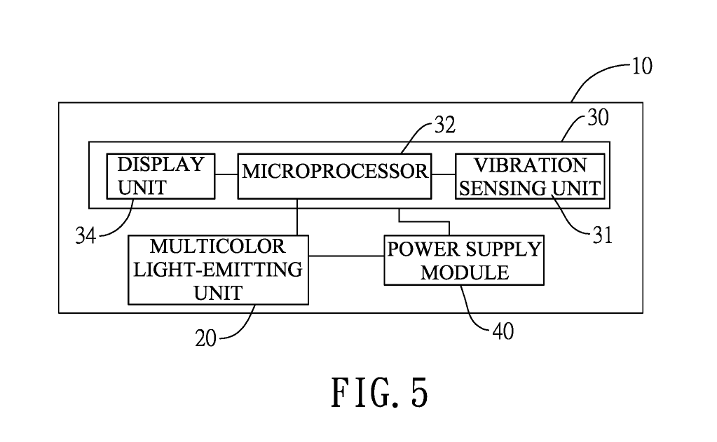

With reference to FIGS. 1 and 5, a first embodiment of a light-emitting pedometer sneaker in accordance with the present invention includes a body 10, at least one multicolor light-emitting unit 20, a pedometer module 30 and a power supply module 40.

The body 10 has a vamp 11 and a sole 12. The vamp 11 is mounted around a top edge of the sole 12. The at least one multicolor light-emitting unit 20 is mounted on the vamp 11 of the body 10. In the present embodiment, the multicolor light-emitting unit 20 is a light-emitting diode (LED) device or an organic light-emitting diode (OLED) device.

The pedometer module 30 is mounted on the sole 12 of the body 10 and is electrically connected to the multicolor light-emitting unit 20 to record a number of steps that a wearer of the light-emitting pedometer sneaker have walked or jogged and controls a color of light emitted from the multicolor light-emitting unit 20 according to the recorded number of steps. The pedometer module 30 has a vibration-sensing unit 31 and a microprocessor 32. An output terminal of the vibration-sensing unit 31 is electrically connected to the microprocessor 32. An output terminal of the microprocessor 32 is electrically connected to the multicolor light-emitting unit 20. The vibration-sensing unit 31 transmits an electronic signal to the microprocessor 32 according to vibration of each step sensed when the wearer is walking. The microprocessor 32 calculates the number of steps according the received electronic signals and further outputs a control signal according to the calculated number of steps to control a light-emitting rule and a blinking rule of light emitted from the multicolor light-emitting unit 20. In the present embodiment, the multicolor light-emitting unit 20 is arranged in the form of a pattern or texts and includes at least one LED and a light-guiding element.

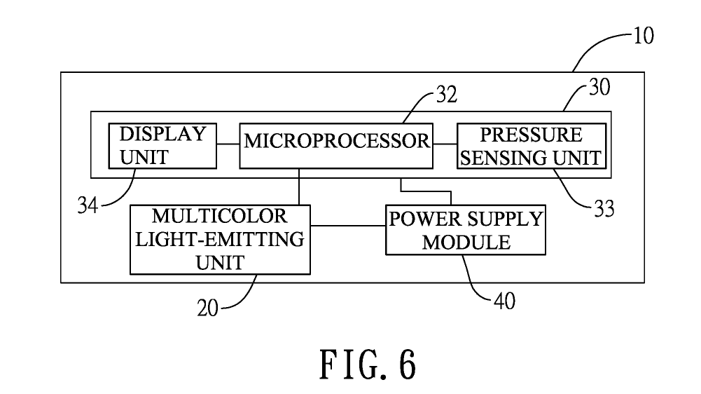

With reference to FIGS. 1 and 6, the vibration-sensing unit 31 of the pedometer module 30 in FIG. 5 can be replaced by a pressure-sensing unit 33. When the pedometer module 30 is equipped with the pressure-sensing unit 30, an output terminal of the pressure-sensing unit 30 is electrically connected to the microprocessor 32 and transmits an electronic signal to the microprocessor 32 according to a pressure variation generated by a foot of the wearer upon walking or jogging each step. The microprocessor 32 calculates the number of steps that the wearer has walked or jogged according to the electronic signal. The microprocessor 32 further outputs a control signal according to the calculated number of steps to control a light-emitting rule and a blinking rule of light emitted from the multicolor light-emitting unit 20. For example, blue light is emitted from the multicolor light-emitting unit 20 when the calculated number of steps is less than 30,000 steps, green light is emitted from the multicolor light-emitting unit 20 when the calculated number of steps is more than 30,000 steps and less than 40,000 steps, yellow light is emitted from the multicolor light-emitting unit 20 when the calculated number of steps is more than 40,000 steps and less than 50,000 steps, and red light is emitted from the multicolor light-emitting unit 20 when the calculated number of steps is more than 50,000 steps.

The pedometer module 30 further has a display unit 34 electrically connected to the microprocessor 32 to display the number of steps calculated by the microprocessor 32.

The power supply module 40 is mounted inside the sole 12 and is electrically connected to the multicolor light-emitting unit 20 and the pedometer module 30 to supply operating power of the multicolor light-emitting unit 20 and the pedometer module 30. For example, the power supply module 40 may be a regular dry cell, which is replaced when the dry cell is empty, or a rechargeable battery, which is electrically connected to and charged by an external power source when the rechargeable battery runs out. Additionally, the power supply module 40 is a solar cell, which is charged when the sunlight is sufficient.

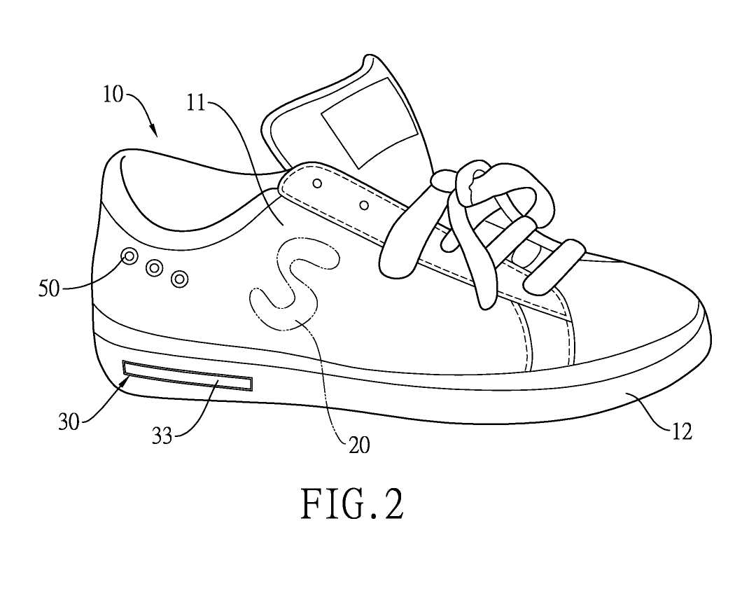

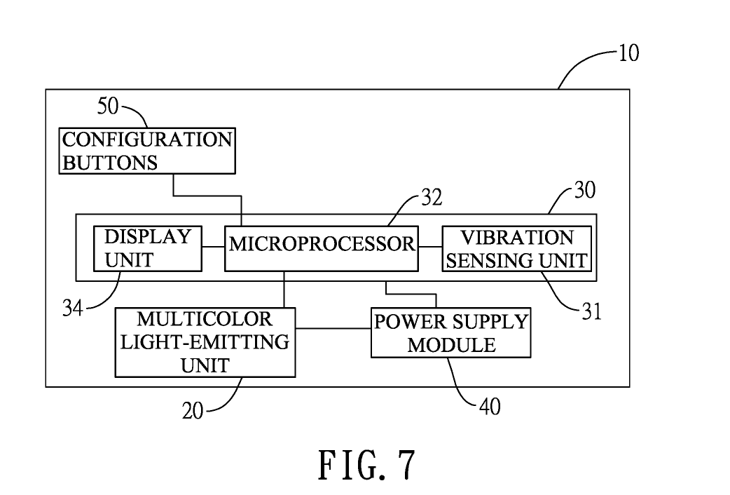

With reference to FIGS. 2 and 7, a second embodiment of a light-emitting pedometer sneaker in accordance with the present invention differs from the first embodiment in an additional set of configuration buttons 50. The set of configuration buttons 50 are electrically connected to the microprocessor 32 and serves for users to configure a target step number stored in the microprocessor 32 of the pedometer module 30. When the calculated number of steps is getting close to the target step number, the microprocessor 32 adjusts the color of light emitted from the multicolor light-emitting unit 20 according to a degree of closeness to the target step number to inform the user of a state that the number of steps the user has walked or jogged approaches the target step number and to remind the user to plan an amount of exercise and not to exercise excessively. When the number of steps that the user has walked or jogged reaches the target step number, the microprocessor 32 of the pedometer 30 then sets the target step number back to zero for the user to reconfigure a new target step number and also sets the current number of steps back to zero for calculation of the number of steps in following exercise. For example, suppose that the user configures the target step number as 50,000 steps. The microprocessor 32 outputs a control signal to control the multicolor light-emitting unit 20 to emit blue light, green light, yellow light or red light when the number of steps calculated by the microprocessor 32 is less than 30,000 steps, when the calculated number of steps is more than 30,000 steps and less than 40,000 steps, when the calculated number of steps is more than 40,000 steps and less than 50,000 steps, or when the calculated number of steps is more than 50,000 steps.

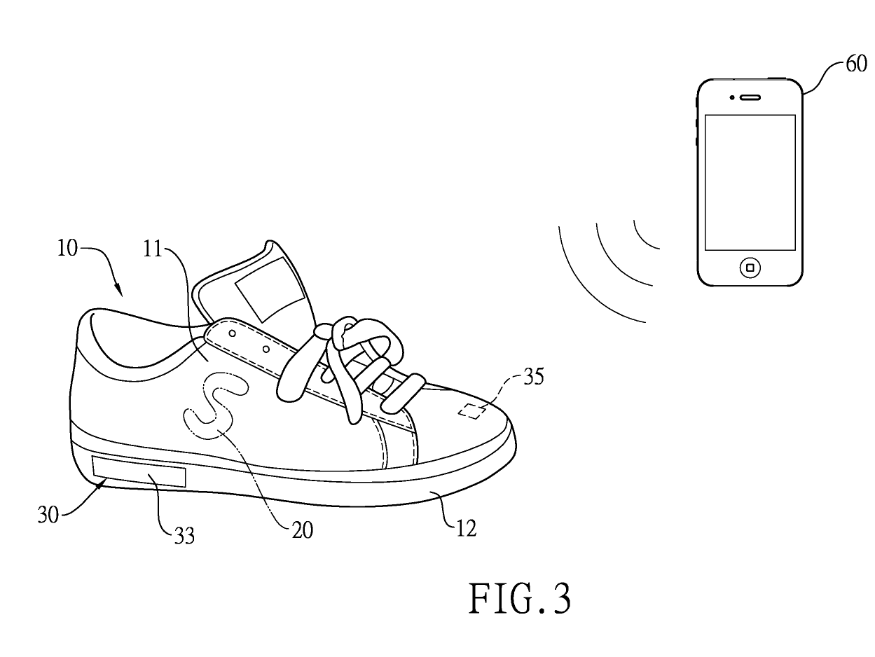

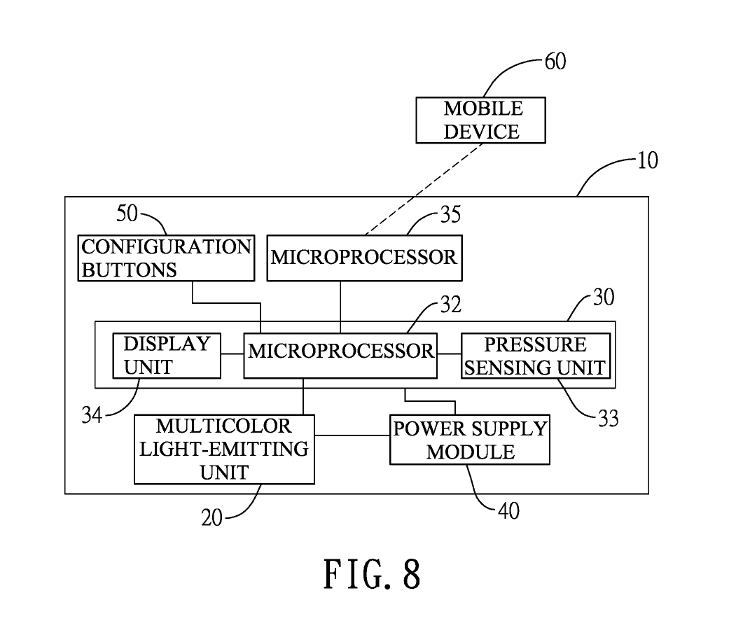

With reference to FIGS. 3 and 8, a third embodiment of a light-emitting pedometer sneaker in accordance with the present invention differs from the first embodiment in an additional signal receiving unit 35 for receiving a configuration signal and transmitting the configuration signal to the microprocessor 32. After receiving the configuration signal, the microprocessor 32 sets the target step number according to the configuration signal. Users can enter the target step number through the mobile device 60. The configuration signal is wirelessly transmitted from a mobile device 60 to the signal receiving unit 35 of the pedometer module 30. In the present embodiment, the mobile device 60 is a smart phone.

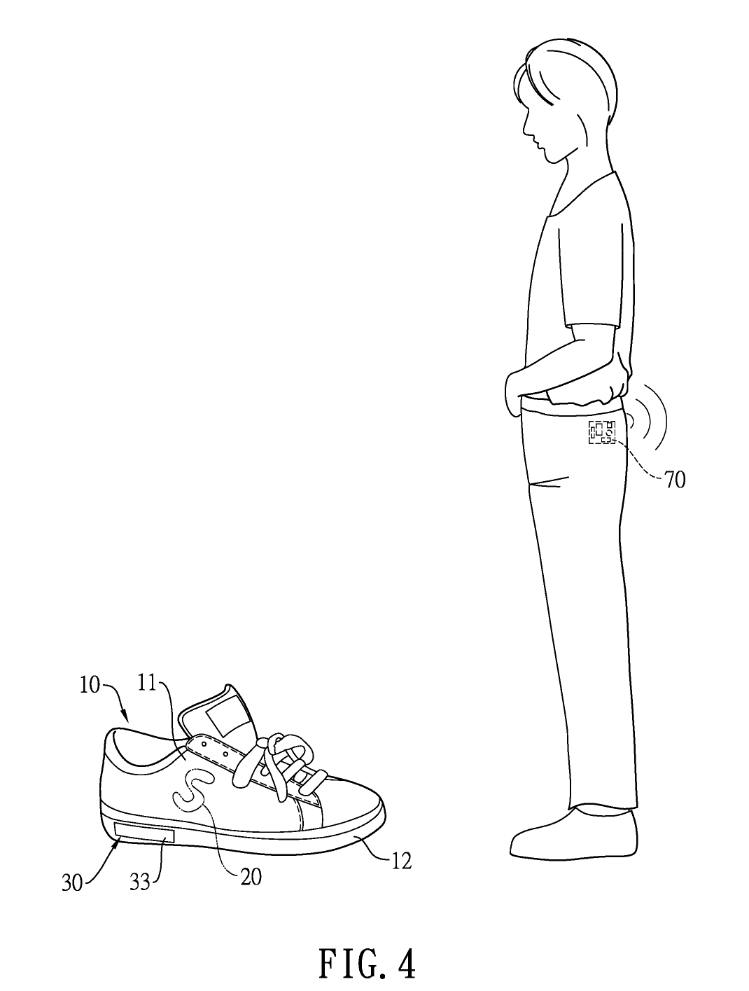

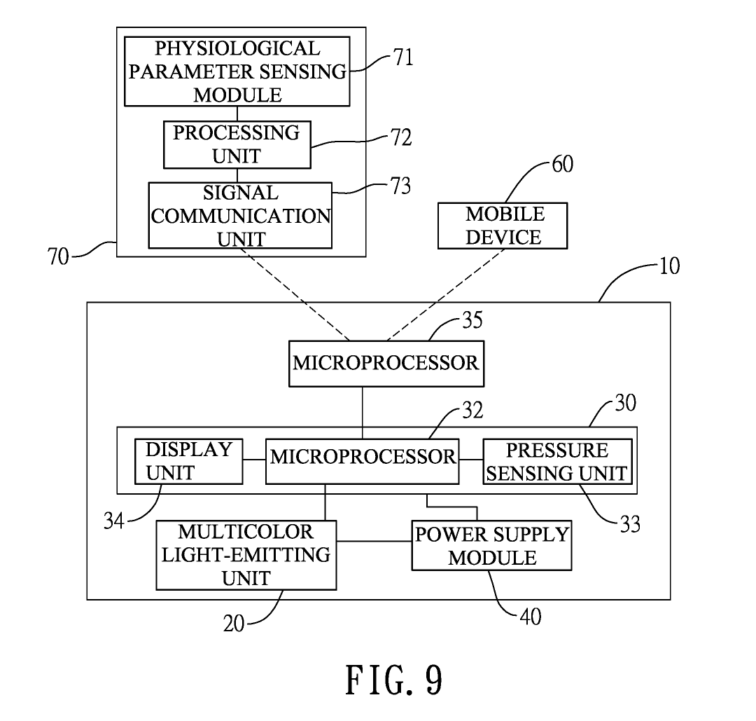

With reference to FIGS. 4 and 9, the light-emitting pedometer sneaker in FIGS. 3 and 8 is operated in collaboration with a health management system 70. The health management system 70 is worn on a user to sense fatigue indices of the user required for determining a physical condition of the user's body and generating a control signal. The health management system 70 includes a physiological parameter sensing module 71, a processing unit 72 and a signal communication unit 73. For example, the health management system 70 senses the fatigue indices, including but not limited to blood urea nitrogen (BUN), creatine kinase (CK), lactate dehydroenase (LDH) and the like, to determine if the current physical condition of the user is good for more amount of exercise.

The processing unit 72 generates the control signal according to the foregoing fatigue indices and transmits the control signal to the signal receiving unit 35 of the pedometer module 30. The signal receiving unit 35 of the pedometer module 30 receives the control signal and transmits the control signal to the microprocessor 32. After receiving the control signal, the microprocessor 32 controls the color of light emitted from the multicolor light-emitting unit 20 according to the control signal as an indication of the physical condition of the user. For example, the microprocessor 32 control the multicolor light-emitting unit 20 to emit green light, yellow light, and red light when the fatigue indices represent a regular physical condition, when the fatigue indices represent a critical physical condition, or when the fatigue indices represent a dangerous physical condition. The indication of red light emitted from the multicolor light-emitting unit 20 intends to inform the user that a danger jeopardizing body health of the user may arise from more amount of exercise.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light-emitting pedometer sneaker, comprising:
a body having:
a sole; and
a vamp mounted around a top edge of the sole;
at least one multicolor light-emitting unit mounted on the vamp of the body;
a pedometer module mounted on the sole of the body and electrically connected to the multicolor light-emitting unit to record a number of steps and to control a light-emitting rule of light emitted from the multicolor light-emitting unit according to the recorded number of steps; and
a power supply module mounted inside the sole and electrically connected to the multicolor light-emitting unit and the pedometer module to supply an operating power to the multicolor light-emitting unit and the pedometer module.

2. The light-emitting pedometer sneaker as claimed in claim 1, wherein the pedometer module has:
a vibration-sensing unit; and
a microprocessor electrically connected to the vibration-sensing unit and calculating the number of steps according to an electronic signal generated by the vibration-sensing unit.

3. The light-emitting pedometer sneaker as claimed in claim 1, wherein the pedometer module has:
a pressure-sensing unit; and
a microprocessor electrically connected to the pressure-sensing unit and calculating the number of steps according to an electronic signal generated by the pressure-sensing unit.

4. The light-emitting pedometer sneaker as claimed in claim 1, further comprising a set of configuration buttons electrically connected to the microprocessor of the pedometer module and serving to set a target step number stored in the microprocessor of the pedometer module.

5. The light-emitting pedometer sneaker as claimed in claim 2, further comprising a set of configuration buttons electrically connected to the microprocessor of the pedometer module and serving to set a target step number stored in the microprocessor of the pedometer module.

6. The light-emitting pedometer sneaker as claimed in claim 3, further comprising a set of configuration buttons electrically connected to the microprocessor of the pedometer module and serving to set a target step number stored in the microprocessor of the pedometer module.

7. The light-emitting pedometer sneaker as claimed in claim 1, further comprising a display unit electrically connected to the microprocessor of the pedometer module to display the number of steps calculated by the microprocessor.

8. The light-emitting pedometer sneaker as claimed in claim 2, further comprising a display unit electrically connected to the microprocessor of the pedometer module to display the number of steps calculated by the microprocessor.

9. The light-emitting pedometer sneaker as claimed in claim 3, further comprising a display unit electrically connected to the microprocessor of the pedometer module to display the number of steps calculated by the microprocessor.

10. The light-emitting pedometer sneaker as claimed in claim 4, further comprising a display unit electrically connected to the microprocessor of the pedometer module to display the number of steps calculated by the microprocessor.

11. The light-emitting pedometer sneaker as claimed in claim 5, further comprising a display unit electrically connected to the microprocessor of the pedometer module to display the number of steps calculated by the microprocessor.

12. The light-emitting pedometer sneaker as claimed in claim 6, further comprising a display unit electrically connected to the microprocessor of the pedometer module to display the number of steps calculated by the microprocessor.

13. The light-emitting pedometer sneaker as claimed in claim 1, further comprising a signal receiving unit receiving a control signal and transmits the control signal to the microprocessor for the microprocessor to control the light-emitting rule of the light emitted from the multicolor light-emitting unit according to the control signal.

14. The light-emitting pedometer sneaker as claimed in claim 2, further comprising a signal receiving unit receiving a control signal and transmits the control signal to the microprocessor for the microprocessor to control the light-emitting rule of the light emitted from the multicolor light-emitting unit according to the control signal.

15. The light-emitting pedometer sneaker as claimed in claim 3, further comprising a signal receiving unit receiving a control signal and transmits the control signal to the microprocessor for the microprocessor to control the light-emitting rule of the light emitted from the multicolor light-emitting unit according to the control signal.

16. The light-emitting pedometer sneaker as claimed in claim 7, further comprising a signal receiving unit receiving a control signal and transmits the control signal to the microprocessor for the microprocessor to control the light-emitting rule of the light emitted from the multicolor light-emitting unit according to the control signal.

17. The light-emitting pedometer sneaker as claimed in claim 1, further comprising a signal receiving unit receiving a configuration signal and transmitting the configuration signal to the microprocessor for the microprocessor to set a target step number according to the configuration signal.

18. The light-emitting pedometer sneaker as claimed in claim 2, further comprising a signal receiving unit receiving a configuration signal and transmitting the configuration signal to the microprocessor for the microprocessor to set a target step number according to the configuration signal.

19. The light-emitting pedometer sneaker as claimed in claim 3, further comprising a signal receiving unit receiving a configuration signal and transmitting the configuration signal to the microprocessor for the microprocessor to set a target step number according to the configuration signal.

20. The light-emitting pedometer sneaker as claimed in claim 7, further comprising a signal receiving unit receiving a configuration signal and transmitting the configuration signal to the microprocessor for the microprocessor to set a target step number according to the configuration signal.
